(19) United States
(12) Patent Application Publication
(10) Pub. No.: US 2003/0111863 A1
(43) Pub. Date: Jun. 19, 2003

(54) Motor vehicle door locking system

(75) Inventors: Bernd Weyerstall, Wuppertal (DE); Stefan Josten, Stuttgart (DE)

Correspondence Address: NIXON PEABODY, LLP, 8180 GREENSBORO DRIVE, SUITE 800, MCLEAN, VA, 22102, US

(73) Assignee: Robert Bosch GmbH, Stuttgart (DE)

(21) Appl. No.: 10/254,015

(22) Filed: Sep. 25, 2002

(30) Foreign Application Priority Data
Dec. 13, 2001 (DE) 101 61 455.1

(51) Int. Cl. B60J 5/00

(52) U.S. Cl. 296/146.1

(57) ABSTRACT

A motor vehicle door locking system which includes locking units that are spaced apart from a control unit. The control unit includes a locking mechanism which actuates each locking unit via a Bowden cable attached from the control unit to each locking unit. The control unit can optionally be provided with lock electronics, and the locking elements can be placed within either or both the vehicle door/hatch or the cutout frame of the vehicle that receives the door/hatch.

### BACKGROUND

1. Field of the Invention

The invention relates to a motor vehicle door or hatch having a door locking system which includes mechanical locking elements, such as a lock latch and a detent pawl, within a locking unit and a lock mechanism within a control unit which is separate from the locking unit. The invention also relates to a motor vehicle body, with a cutout frame and a motor vehicle door or hatch inserted into the frame, and including the door locking system mentioned above.

The invention further relates to integration of a motor vehicle door locking system into a motor vehicle door or hatch or into the body of a motor vehicle in conjunction with a cutout frame into which a motor vehicle door or hatch is inserted. Both the side doors of a motor vehicle, as well as the rear door(s) or rear hatch(es), trunk lid, and in the extreme situations a hood, can be included in the door locking system of the invention.

2. Description of Related Art

Motor vehicle door locks are known to exist in a host of embodiments. Often, the motor vehicle door lock includes a central interlock drive, an opening drive, and an auxiliary locking drive, all driven by an electric motor. One example of this arrangement can be found in published European Patent Application EP 0 894 920 A1. In this motor vehicle door lock, there are a host of microswitches on the locking elements and in the lock mechanism, each microswitch is partially constructed as a proximity sensor, particularly a Hall sensor, with signals which are evaluated and converted in the lock electronics.

In particular, in the lock mechanism and lock electronics of the prior art, the question of moisture entry is important, and the above known motor vehicle door locks require special shielding measures.

Conventionally, a motor vehicle door or hatch has a wet space facing the outside door wall, into which space moisture enters in often considerable amounts from the top, and a dry space which is separate from the wet space and is conversely generally sealed against moisture while pointing toward the inside of the motor vehicle door or hatch. In the wet space, there are necessarily locking elements which are located normally on the face of the motor vehicle door or hatch. While in the dry space, the electrical components and means, for example speakers, etc., are positioned. Additionally, wet space/dry space separation has already been known for electrical window raisers.

In the prior art, published German Patent Application DE 44 44 581 A1 discloses that wet space/dry space separation can also be done for a motor vehicle door lock. In this motor vehicle door lock, the mechanical locking elements, i.e., the lock latch and detent pawl, are combined in a locking unit within one encapsulated housing located in the wet space. In the dry space, connected via Bowden cables to the locking unit, is the separate control unit with an electric drive motor and lock electronics. There is also an inside door handle arrangement in the dry space. The use of a remote power transmission means, like a Bowden cable, which penetrates the wet/dry separation of the motor vehicle door or hatch, makes it possible to house the moisture-sensitive control unit in the dry space without adversely affecting the serviceability of the motor vehicle door lock overall.

In this published prior art, it is necessary that the control unit has a total of five mechanical connections through remote power transmission means and a number of electrical connecting elements which are not explained in detail.

Flexibility in the installation of components of the motor vehicle door locking system into a motor vehicle door or hatch is clearly enhanced when the connection of the individual components is no longer made by remote power transmission means, particularly Bowden cables. However, the enhancement is only realized when all electrical connections are implemented because the locking units are all electric locks, as is disclosed in published German Patent Application DE 195 45 722 A1.

It is basically known that a motor vehicle door locking system needs to necessarily be located in the motor vehicle door or hatch; however, a complementary arrangement on the cutout frame of the motor vehicle body can also be chosen. For this, the motor vehicle door or hatch has a stationary key collar assigned to the locking unit.

### SUMMARY OF THE INVENTION

A primary object of the present invention is to devise a motor vehicle door locking system that can be integrated into a motor vehicle door or hatch in or on the cutout frame of a motor vehicle body even when there is no support “B” column or other form of abutment for the locking of the motor vehicle door or hatch.

It has been found that in a more complex motor vehicle door locking system with several spaced locking units, it is easily possible to have all locking units of the door locking system controlled from a central control unit and nevertheless maintain the basic principle of using a mechanical remote power transmission means. With an arrangement of the control unit of the invention, the remote power transmission means can be shifted to the various components of the motor vehicle door locking system such that no technical problems occur. The use of mechanical remote power transmission means in several locking units, as are used for example in sliding doors and in bodies without a “B” column, has the great advantage that the locking units themselves can be made very small. In contrast to the prior art motor vehicle door locking system having electric locks, the instant invention each locking unit abandons the use of an electric motor drive and step-down gearing for the locking element, particularly, the detent pawl. The space requirement for the mechanical actuation of the lock element is much less than the space requirement for these electrical/electromechanical components. Thus, locking units can also be housed at locations where in the past the arrangement of a locking unit had not been considered or the arrangement of a locking unit required major structural changes.

The present invention relates to completely installed motor vehicle door locking systems, either in a motor vehicle door or hatch, or on the cutout frame for the motor vehicle door or hatch, as described in greater detail below with reference to the drawing figures.

### BRIEF DESCRIPTION OF THE DRAWINGS

FIG. 1 shows one example of a motor vehicle having a motor vehicle body without a supporting “B” column in which the current door lock system can be used,

FIG. 2 shows, schematically, a motor vehicle door with an integrated motor vehicle door locking system of the invention,

FIG. 3 shows, schematically, a motor vehicle door located in the cutout frame of a corresponding motor vehicle body having integrated therein the motor vehicle door locking system of the invention,

FIG. 4 shows a more detailed view of the motor vehicle door locking system of the invention in conjunction with a motor vehicle door, and

FIG. 4A is an enlarged view of the encircled detail A of FIG. 4.

### DETAILED DESCRIPTION OF THE INVENTION

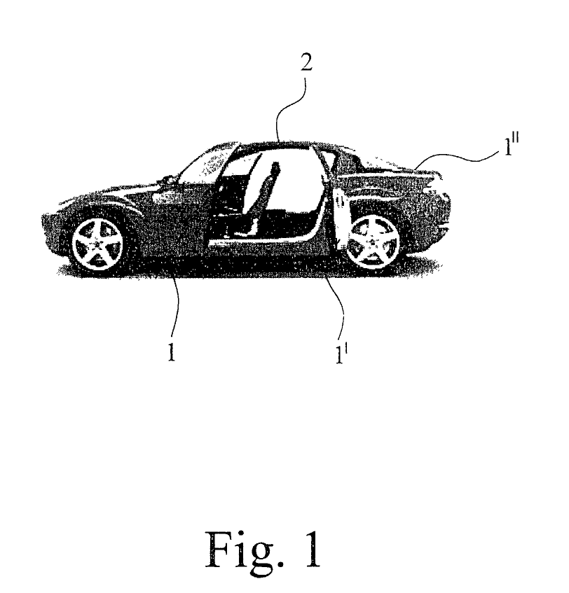

FIG. 1 shows a motor vehicle with a corresponding motor vehicle body with two doors 1, 1′ in a cutout frame 2 of the motor vehicle body. The trunk lid 1″ is also shown.

It is apparent that there is no support “B” column in the motor vehicle body as shown in FIG. 1. The cutout frame 2 is closed by the two side doors 1, 1′ with direct contact of the side edges of the doors with one another. Due to the absence of the “B” column of the motor vehicle body, a classical motor vehicle door locking system cannot be used here.

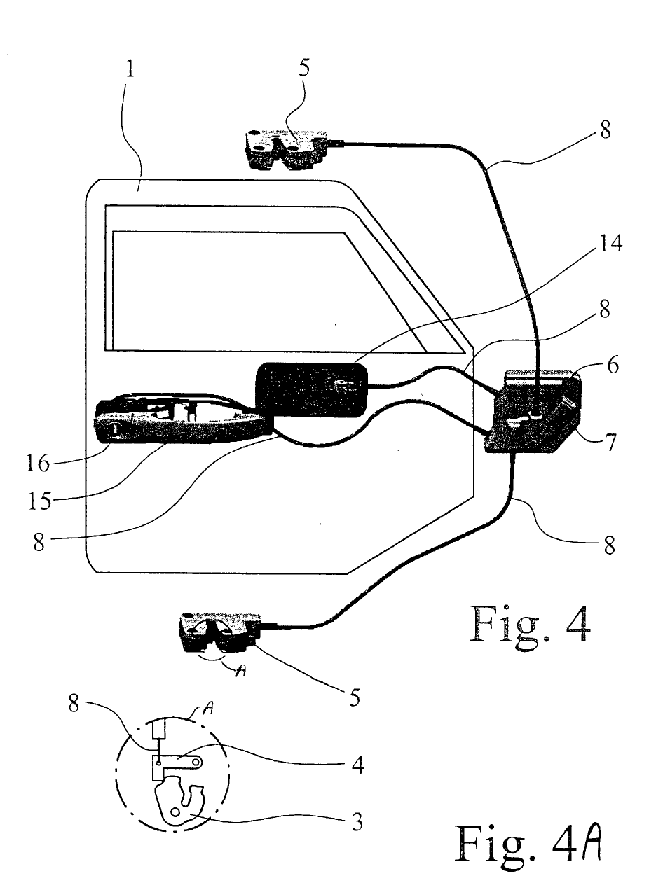

In order to explain the motor vehicle door locking system of the invention, reference should be made to FIGS. 4 & 4A. The enlarged detail shown in FIG. 4A shows mechanical locking elements 3, 4, specifically, a lock latch 3 and a detent pawl 4, as the typical equipment of a mechanical locking unit 5.

Furthermore, there is a lock mechanism with several interacting elements in a control unit 6 which is separate from the locking unit 5. Details of the structure of such a control unit do not, by themselves, form part of the present invention and those skilled in the are will be able to select a suitable unit with lock electronics for performing the control functions described herein. An electric drive motor 7 can include a central interlock drive and an anti-theft drive, as well as an opening aid, as are known for electric drives for vehicle lock systems.

The locking unit 5 is spaced apart from the control unit 6 at the location provided for this purpose in the motor vehicle door 1 and is connected to the control unit 6 by means of a remote mechanical power transmission means 8, which in a preferred embodiment is a Bowden cable. A locking element, specifically here the detent pawl 4 in the locking unit 5, can be mechanically actuated by an element of the lock mechanism in the control unit 6 by the remote power transmission means 8. That is, the detent pawl 4 is raised out of the corresponding catch of the lock latch 3, by pulling the core of the Bowden cable, in order to be able to open the motor vehicle door 1.

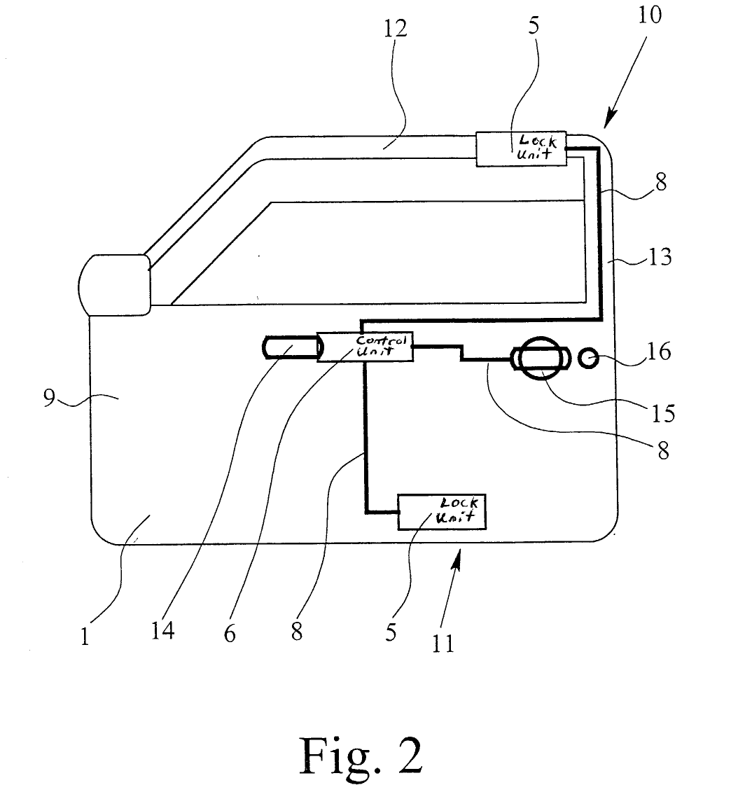

FIG. 2 shows that, in the motor vehicle door 1, two locking units 5 are located spatially distributed at the locations provided for this purpose. Incidentally, there need not be only two locking units 5, that is, several spatially distributed, additional locking units 5 can be provided. The control unit 6 is connected to each of the locking units 5 via a respective remote power transmission means 8. The locking elements of all locking units 5 can be mechanically actuated from the control unit 6. The control unit 6 can therefore combine all control functions of this motor vehicle door locking system within the motor vehicle door 1 shown. Further, the locking units 5 are also actuated mechanically via a remote power transmission means 8, which is preferably a Bowden cable. The reduction of the locking units 5 to the mechanically essential components makes it possible to make the locking units 5 very small. Therefore, the locking units 5 can be attached at locations which had not been considered in the past for attachment of these locking units 5.

The embodiment shown in FIG. 2 makes it clear that, particularly with to a door frame design that lacks a supporting “B” column, the locking units 5 are located away from the hinge side 9 of the motor vehicle door 1, on the top and bottom edges 10, 11 for a motor vehicle side door. With reference to FIG. 1, it can be easily understood that for a trunk lid 1″, the locking units 5 will be located on the right and left edge of the trunk lid 1″.

It is important that the locking units 5 engage the roof frame and the bottom flange of the motor vehicle body at corresponding locations, especially via key collars and thus securely fix the motor vehicle door 1 in the locked state in spite of the lack of a “B” column on the motor vehicle body.

FIG. 2 shows a particularly preferred embodiment of the invention where the remote power transmission means 8, wherever possible, are located in a frame crossbeam 12 of the motor vehicle door or hatch 1. Particularly advantageous is the positioning of the remote power transmission means 8 in the window frame 13, for a locking unit 5 located in or on the upper frame crossbeam 12 of the motor vehicle door.

Of course, the locking units 5, with the interposition of the control unit 6, must be able to be actuated in some way. For this reason, this embodiment provides that the inside door handle 14 and/or the outside door handle 15 and/or the locking cylinder 16 of the motor vehicle door locking system is located in the motor vehicle door or hatch 1 at a distance from the control unit 6 and is connected to the control unit 6 via remote power transmission means 8, e.g., a Bowden cable, so that the locking elements of the locking units 5 are actuated only via the control unit 6. In any case, FIG. 2 shows a preferred embodiment where the module which forms the inside door handle 14 is combined with the control unit 6 so that, in this respect, a remote power transmission means 8 between the inside door handle 14 and the control unit 6 can be omitted for the purposes of the invention.

FIG. 4 illustrates, in more detail, the above explained overall arrangement of the motor vehicle door locking system of the invention. What is essential in this embodiment is the distribution of the individual components in the motor vehicle door 1 and their connection via a remote power transmission means 8, not via electrical connecting means. However, the remote power transmission means can be easily provided with electrical connecting means integrated into or combined with the remote power transmission means 8. Such an embodiment will save line installations for switch interrogations, etc. For details of this further embodiment, reference is made to commonly owned, co-pending U.S. Pat. application Ser. No. 10/184,051, the disclosure of which is hereby incorporated by reference.

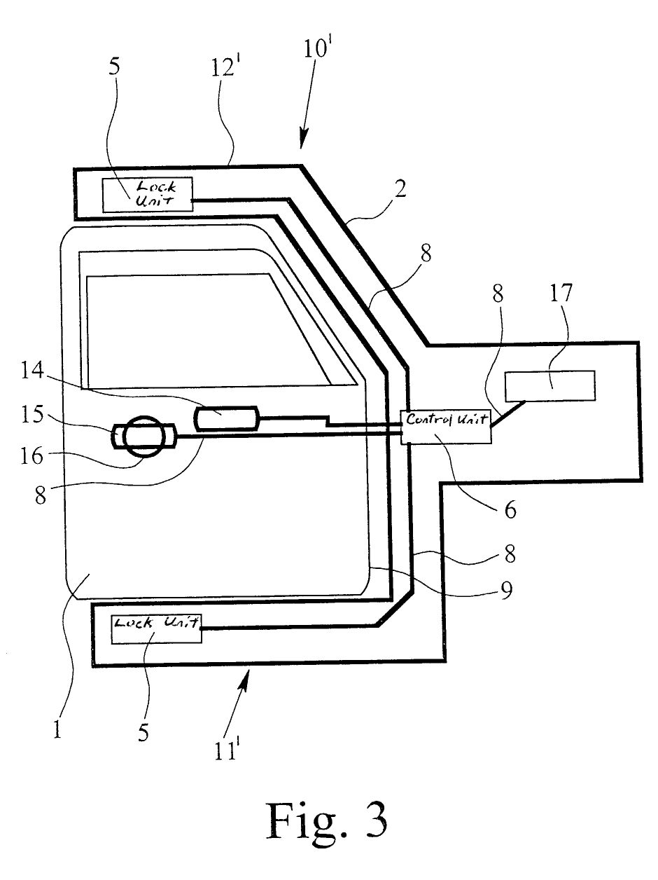

FIG. 3 shows an embodiment of the invention in which the motor vehicle body holds the motor vehicle door locking system in its cutout frame 2. Otherwise, the corresponding explanation for the preceding embodiment of FIG. 2 above applies for this embodiment. In this embodiment, it is important that the locking units 5 are located spaced apart from the control unit 6 at the locations intended for this purpose, i.e., in or on the cutout frame 2. The control unit 6 is connected to each of the locking units 5 via a mechanical remote power transmission means 8 so that the locking elements of all locking units 5 are mechanically actuated from a single control unit 6 in or on the cutout frame 2. The locking units 5 are located away from the hinge side 9 of the vehicle door 1 on the top edge 10′ and on the lower edge 11′ of the cutout frame 2. For a motor vehicle hatch this would be the right and left edge of the cutout frame. In this embodiment, the remote power transmission means 8, which leads to the upper edge 10′ holding the corresponding locking unit 5, is located in the top frame crossbeam 12′ of the cutout frame 2. Accordingly, the remote power transmission means 8 is located in the lower flange 11′ of the cutout frame 2 along with a locking unit 5.

Of particular note in regard to the embodiment of FIG. 3, the inside door handle 14 and/or the outside door handle 15 and/or the locking cylinder 16 are each located in the motor vehicle door or hatch 1, and the respective remote power transmission means 8 extends from the motor vehicle door or hatch 1 into the cutout frame 2 to the control unit 6 located in the cutout frame 2. Alternatively, the outside door handle 15 can be located on the cutout frame 2, and optionally, integrated with the control unit 6, while the inside door handle 14 is attached as previously described in the motor vehicle door 1.

The embodiment shown in FIG. 3 further includes an arrangement of the control unit 6 on the cutout frame 2 of the body along with another locking unit 17 not part of the cutout frame 2, for example a locking unit for a trunk lid 1″ or a fuel tank flap which is located elsewhere on the motor vehicle body and connected via a remote power transmission means 8 to the control unit 6.

It is noted that the embodiment shown in FIG. 3 requires that the mechanical remote power transmission means 8 be on the hinge side 9 to be routed from the cutout frame 2 into the motor vehicle door 1. In order to eliminate the cyclic bending stresses which occur such a routed power transmission means, which can be a problem in terms of wear, the remote power transmission means 8 can be replaced with an electrical connecting line. With this embodiment, however, the mechanical remote power transmission means 8 from the control unit 6 to the locking units 5 remain.

What is claimed is:

1. Motor vehicle door or hatch with a motor vehicle door locking system, the motor vehicle door locking system comprising:
at least two locking units each containing locking elements,
a control unit separate from the locking units and containing a lock mechanism for actuating the locking elements of the at least two locking units, and
at least two remote mechanical power transmission means adapted to mechanically actuate the locking elements of the at least two locking units and which are attached to the control unit and extend to each of the at least two locking units,
wherein the at least two locking units are located spaced apart from the control unit at a location within the vehicle door or hatch.

2. Motor vehicle door or hatch as claimed in claim 1, wherein the at least two locking units are located away from a hinge side of the motor vehicle door at least at one of a top edge and a bottom edge of a motor vehicle door

3. Motor vehicle door or hatch as claimed in claim 1, wherein the at least two locking units are located away from a hinge side of the motor vehicle hatch on right and left edges of the motor vehicle hatch.

4. Motor vehicle door or hatch as claimed in claim 1, wherein the at least two remote power transmission means are located in a frame crossbeam of the motor vehicle door or hatch.

5. Motor vehicle door or hatch as claimed in claim 4, wherein one of the at least two remote power transmission means extends within a window frame of the motor vehicle door to a locking unit located on an upper frame crossbeam of the window frame of the motor vehicle door.

6. Motor vehicle door or hatch as claimed in claim 1, wherein the motor vehicle door locking system further comprises
at least one of an inside door handle, an outside door handle, and a locking cylinder located in the motor vehicle door or hatch at a distance from the control unit and connected to the control unit via another remote power transmission means such that the locking elements of the locking units are actuated only by the control unit and via the at least two remote power transmission means.

7. Motor vehicle door or hatch as claimed in claim 6, wherein the inside door handle is combined with the control unit.

8. Motor vehicle body including a cutout frame, a motor vehicle door or hatch inserted into the cutout frame, and a motor vehicle door locking system, the motor vehicle door locking system, comprising:
at least two locking units each containing locking elements,
a control unit separate from the locking units and containing a lock mechanism for actuating the locking elements of the at least two locking units, and
at least two remote mechanical power transmission means adapted to mechanically actuate the locking elements of the at least two locking units and which are attached to the control unit and extend to each of the at least two locking units,
wherein the at least two locking units are located spaced apart from the control unit at a location within the cutout frame receiving the motor vehicle door or hatch.

9. Motor vehicle body as claimed in claim 8, wherein the at least two remote power transmission means are located in a frame crossbeam of the cutout frame.

10. Motor vehicle body as claimed in claim 8, wherein the motor vehicle door locking system further comprises
at least one of an inside door handle, an outside door handle, and a locking cylinder located in the motor vehicle door or hatch at a distance from the control unit and connected to the control unit via another remote power transmission means such that the locking elements of the locking units are actuated only by the control unit and via the at least two remote power transmission means.

11. Motor vehicle body as claimed in claim 10, wherein the another remote power transmission means extends from the motor vehicle door or hatch into the cutout frame to the control unit located in the cutout frame.

12. Motor vehicle body as claimed in claim 11, wherein the outside door handle is located on the cutout frame and combined with the control unit.

13. Motor vehicle body as claimed in claim 8, further includes an additional locking unit for at least one of a trunk lid and a fuel tank flap wherein the additional locking unit is connected via another remote power transmission means to the control unit which is adapted to actuate the additional locking unit via the another remote power transmission means.

14. Motor vehicle body as claimed in claim 10, wherein the another remote power transmission means is an electrical connecting line.

15. Motor vehicle body as claimed in claim 8, wherein the at least two remote power transmission means are Bowden cables.

16. Motor vehicle door or hatch as claimed in claim 1, wherein the at least two remote power transmission means are Bowden cables.

17. Motor vehicle body as claimed in claim 8, wherein the lock mechanism of the control unit includes lock electronics.

18. Motor vehicle door or hatch as claimed in claim 1, wherein the lock mechanism of the control unit includes lock electronics.

19. Motor vehicle body as claimed in claim 8, wherein the lock elements of the at least two locking units comprise a lock latch and detent pawl.

20. Motor vehicle door or hatch as claimed in claim 1, wherein the lock elements of the at least two locking units comprise a lock latch and detent pawl.
